(19) United States
(12) Patent Application Publication
(10) Pub. No.: US 2013/0031785 A1
(43) Pub. Date: Feb. 7, 2013

(54) Blade Assembly of a Hedge Trimmer

(71) Applicant: Klaus Kaupp, Stuttgart (DE)

(72) Inventor: Klaus Kaupp, Stuttgart (DE)

(21) Appl. No.: 13/567,778

(22) Filed: Aug. 6, 2012

(30) Foreign Application Priority Data
Aug. 5, 2011 (DE) 10 2011 109 512.1

(51) Int. Cl. B26B 19/06; A01G 3/053

(52) U.S. Cl. 30/208; 30/223

(57) ABSTRACT

A blade beam of a motor driven hedge trimmer has two shearing knives. A shearing knife is movable in an oscillating manner through a stroke between two reversal points in the opposite direction with respect to the other shearing knife. Both shearing knives have spaced-apart cutting teeth that act against each other, and are at least partially provided with shearing blades for the chipless, shearing severing of material to be cut. A first cutting tooth of the one shearing knife lies at least partially in overlap with a first or second cutting tooth of the other shearing knife at the two reversal points. The blade beam has a trim cut region, in which the first cutting tooth of the one shearing knife completely glides, between its two reversal points, over a third cutting tooth lying between the first and the second cutting tooth of the other shearing knife.

### CROSS REFERENCE TO RELATED APPLICATION

This application claims priority of German patent application no. 10 2011 109 512.1, filed Aug. 5, 2011, the entire content of which is incorporated herein by reference.

### FIELD OF THE INVENTION

The invention relates to a blade assembly of a hedge trimmer having the features according to the preamble of claim 1 as well as a hedge trimmer having such a blade assembly.

### BACKGROUND OF THE INVENTION

Motor driven hedge trimmers in known construction types have a blade beam having two shearing knives. Either one of the two shearing knives is fixed while the other shearing knife can move in an oscillating manner relative thereto between two reversal points, or both shearing knives can move in an oscillating manner in opposing directions between two reversal points. Both shearing knives have cutting teeth which act against each other and are arranged at regular intervals with respect to each other. For thin and comparatively soft twigs, branches or other comparable material to be cut, the cutting teeth are provided with shearing blades on their flanks for chipless, shearing severing of material to be cut.

For a shearing, chipless cut of this type, the material to be cut is introduced into the cutting space between two adjacent cutting teeth. In order for this to be possible, the cutting teeth of the one shearing knife lie at their reversal points in overlap with the shearing teeth of the other shearing knife, as a result of which the intermediate cutting space is free to receive the material to be cut. Starting from the reversal points, the two shearing knives together with their cutting teeth execute a relative movement, the speed profile of which up to the next reversal point has the shape of a half sine curve. The chipless severing cut takes place at a point in time when two cutting teeth running in opposite directions approach each other and are close to their movement reversal point. As a result of the aforementioned sinusoidal speed profile, the cutting speed is low here, in comparison to the maximum movement speed. This is especially disadvantageous in the case of thin and tough material to be cut which is to be severed by a fine so-called trim cut. In such cases, a tearing off or a fraying of the cuts can be seen instead of a clean shearing cut.

An increase of the drive speed for increasing the cutting speed is only possible to a limited extent because a great deal of technical effort is required for this. In order to mount the blade drive in the form of a connecting rod drive or a link drive, a rolling bearing must be used as of a certain drive speed in order to ensure the required durability. The effort involved therewith is, however, not economically justifiable for many applications.

Furthermore, embodiments of blade beams are known in which saw teeth are provided at least in sections for a chipping separation cut. Saw teeth of this type are provided for the severing of thicker and harder branches, where the problem of tearing off or fraying does not occur. The thick branches are not guided between the saw teeth. Instead, the saw teeth are guided laterally to the branches, the tips of the saw teeth executing a chip-removing cut. A chip-removing cut of this type is done both with a low cutting speed at the reversal points and with a higher cutting speed corresponding to the sinusoidal speed profile in the middle region between the reversal points.

In order to perform such a saw cut, the branches to be cut must be sufficiently thick and unyielding. This enables a lateral pressure to be applied by the blade beam onto the branch in order to start the chipping procedure. The thin and yielding material to be cut in the case of a fine trim cut cannot be worked on with such a saw arrangement because in such a case a chip-removing separation cut would not occur and at best fraying damage would occur to the material to be cut. The cutting conditions with a chipping saw tooth configuration are thus not transferable to the cutting conditions with a configuration, which is the basis of the invention, for chipless, shearing severing of material to be cut, in particular for a fine trim cut.

### SUMMARY OF THE INVENTION

It is an object of the invention to develop a blade beam of the generic type such that an improved cutting result is achieved even with thin, flexible and tough material to be cut.

The blade beam of the invention is for a motor driven hedge trimmer. The blade beam includes: a first and a second shear knife, at least one of the first and the second shear knives being configured to be moveable in an oscillating manner counter to the other one of the shearing knives by a stroke between two reversal points; the first and the second shear knives each having cutting teeth which are arranged at a distance (a) one from the other; the cutting teeth of the first shear knife and the cutting teeth of the second shear knife being configured to act in opposition to each other; a portion of the cutting teeth having cutting edges for carrying out a chipless, shearing severing of material to be cut; the first and the second shear knives having respective first cutting teeth; the first and the second shear knives being configured so as to cause the first cutting tooth of one of the first and second shear knives to be at least in partial overlapment with the first cutting tooth of the other one of the first and the second shear knives at the two reversal points; a trim cut region having at least a subset of the cutting teeth including the first cutting tooth, a second one of the cutting teeth and a third one of the cutting teeth disposed between the first and second cutting teeth; the cutting teeth in the trim cut region being at the distance (a) from each other; and, the distances (a) between the three cutting teeth and the stroke being matched to each other so as to cause the first cutting tooth of one of the first and the second shear knives to completely glide over the third cutting tooth of the other one of the first and the second shear knives as the first shear knife moves between the two reversal points.

Further, it is an object of the invention to provide a hedge trimmer, the range of application of which is expanded.

A blade beam is suggested which has at least one trim cut region, in which the spacings between the cutting teeth and the stroke are coordinated with each other in such a manner that, between its two reversal points, the first cutting tooth of the one shearing knife glides completely over a third cutting tooth which lies between the first and second cutting tooth of the other shearing knife. Here, it can be expedient, that, along with the mentioned third tooth, one or more further intermediate cutting teeth are completely glided over. Preferably, the mentioned third cutting tooth lies directly adjacently between the first and second cutting teeth, so that only this single third cutting tooth is glided over completely. In particular, the spacing between the cutting teeth of at least one of the two shearing knives, and in particular of both shearing knives, are uniform in the course of the trim cut region. In other words, the cutting teeth are each at the same spacing from each other along the trim cut region. As a result, it is ensured that the same geometric conditions exist for all cutting teeth while cutting.

The invention is based on the consideration that the individual shearing knives have the speed profile in the form of a half sine curve, as described above, according to which the moving speed is at a maximum at the central point between the two reversal points. As a result, the first cutting tooth of the one shearing knife glides over the aforementioned intermediate third cutting tooth of the other shearing knife in the region of its maximum speed, from which a maximum cutting speed results. It is assumed that this moving and cutting speed which is increased with respect to the prior art leads to a clean shearing cutting result, in particular with thin, flexible and tough material to be cut. Additionally, shearing cutting also takes place in the region of the two reversal points, so that with each stroke twice as many chipless shearing cuts are executed in comparison with the prior art. Overall, an increased cutting power with a clean cutting result is combined without the drive speed needing to be increased. Rather, the drive speed can be kept low, such that cost intensive speed increasing measures such as rolling bearings or the like can be dispensed with.

In a preferred embodiment of the invention, the spacing between the cutting teeth in the trim cut region is equal to half the sum of the stroke of the one shearing knife and of the stroke of the other shearing knife. Here, the stroke of both shearing knives can be equal in magnitude but offset through 180°. It is also possible that one shearing knife stands still while the other shearing knife moves with a correspondingly adapted stroke relative thereto. In all aforementioned cases, it is ensured that at the reversal points, the cutting teeth of the one shearing knife lie in an overlapping manner with the corresponding cutting teeth of the other shearing knife, with the intermediate cutting spaces being open for the insertion of material to be cut. Furthermore, the middle, third cutting teeth are glided over at a maximum relative speed.

In an advantageous variant of the invention, the cutting teeth of the one shearing knife, at least in a partial section of the trim cut region, are at a spacing from each other which is different from the spacing between the associated cutting teeth of the other shearing knife. Here, it can be expedient that the tooth spacing within one or both shearing knives is constant, wherein, however, the tooth spacings of the one shearing knife are different than the tooth spacings of the other shearing knife. Advantageously, the spacing between the cutting teeth of at least one of the two shearing knives and especially of both shearing knives is irregular in the course of the trim cut region. As a result, it is achieved that not all cutting teeth of the trim cut region perform a shearing of the material to be cut at the same time. Rather, the shearing at different cutting teeth occurs at different times, which relieves the drive as well as the mounting of the moving parts.

Preferably, the spacing between the cutting teeth in the trim cut region is greater than/equal to half the sum of the stroke of the one shearing knife and of the stroke of the other shearing knife. In particular, the spacing between the cutting teeth of the one shearing knife becomes greater from one end of the blade beam to its opposite end, while the spacing between the cutting teeth of the associated other shearing knife becomes smaller from the same end of the blade beam to its opposite end. With the aforementioned advantages being retained, it is ensured that in the total trim cut region one section is always performing shearing while in adjacent sections the cutting teeth are so positioned as to create a gap and thus enable insertion of material to be cut into the intermediate spaces between the cutting teeth.

The blade beam has a usable length for the cut, in that the shearing knife is provided with cutting teeth. It can be expedient to provide a shortened trim cut region which extends only over a portion of the mentioned usable length. Preferably, the trim cut region extends over the entire usable length of the blade beam on at least one side thereof. When trimming shrubs, bushes or the like, the operator can use the entire available length of the blade beam with a continuously uniform cutting result, as a result of which clean and extensive trim areas can be achieved.

The blade beam has two opposing sides in relation to its longitudinal axis. In a preferred embodiment, a trim cut region is provided on each of these two sides of the blade beam. This enables the operator to guide the hedge trimmer in both lateral directions and thereby achieve a clean trim cut in both lateral directions, which especially facilitates the trimming of large areas. In particular, in this case the shearing knives are configured symmetrically in relation to the trim cut region on both sides in such a manner that the cutting teeth in the trim cut region are arranged either in a mirror-symmetrical manner in relation to the longitudinal axis of the shearing knife or in a rotationally symmetrical manner in relation to a vertical axis which is located centrally in the trim cut region. In other words, the rotational symmetry means that the cutting teeth on one side of the shearing knife can be brought into overlap with the cutting teeth on the opposite side of the shearing knife by rotating through 180°, when the imaginary 180° rotation takes place about an imaginary vertical axis which is perpendicular to the plane of the shearing knife, and which thereby runs through the trim cut region, or through the region of the cutting teeth. This enables the use of two identical shearing knives which face each other so that different parts do not have to be provided. Aside from the reduction in the part diversity, the risk of defective assembly is reduced because the operator does not have to consider which shearing knife belongs in which installation position.

Alternatively, it can be expedient for a trim cut region to be provided on one side and a rough cut region or back cut region with cutting teeth arranged at regular spacings from each other to be provided on the opposite side, with the spacing between the cutting teeth in the rough cut region being greater than the spacing between the cutting teeth in the trim cut region. In particular, the spacing between the cutting teeth in the rough cut region is twice that of the spacing between the cutting teeth in the trim cut region. As a result of the greater tooth spacing in the rough cut region, there are no intermediate teeth which are completely glided over with the same stroke. This facilitates the insertion of coarser material to be cut into the cutting spaces located between the cutting teeth, as a result of which greater work progress can be achieved compared with the trim cut region.

It can be expedient for only a portion of the cutting teeth to be provided with shearing blades while another portion of the cutting teeth corresponding thereto has a simple, non-sharpened edge. The meeting of such an edge with a sharpened shearing blade also leads to the desired shearing cut. Preferably, however, all of the cutting teeth are provided with shearing blades for the chipless, shearing severing of material to be cut, as a result of which a clean cutting result can be achieved with low drive power.

In a preferred embodiment, the cutting knives of the blade beam are exchangeable. This enables, depending on application, the use of cutting knives with or without a trim cut region, as a result of which the respectively optimal work result can be achieved.

In a further development according to the invention, a hedge trimmer having exchangeable blade beams is provided. One of these blade beams has at least one trim cut region in a manner according to the invention. Further, a further blade beam having at least one rough cut region and no trim cut region is provided, with the blade beam having the at least one trim cut region being exchangeable with the blade beam without a trim cut region. As a result, the hedge trimmer can be reconfigured from trim cut operation to rough cut operation at the work site with just a few manipulations.

### BRIEF DESCRIPTION OF THE DRAWINGS

The invention will now be described with reference to the drawings wherein:

FIG. 1 shows a perspective view of a motor driven hedge trimmer having a blade beam and exchangeable shearing knives;

FIG. 2 shows a perspective view of two oppositely drivable shearing knives according to the prior art for use in a hedge trimmer according to FIG. 1;

FIG. 3 shows a plan view of the arrangement according to FIG. 2 with cutting teeth at a spacing from each other which is twice the single stroke of both shearing knives;

FIG. 4 shows a schematic view of the cutting teeth according to FIGS. 2 and 3 at their reversal points with a graph-like illustration of their speed profile;

FIG. 5 shows the arrangement according to FIG. 4 with the not yet interacting cutting teeth in the region of their maximum moving speed;

FIG. 6 shows the arrangement according to FIGS. 4 and 5 with the cutting teeth during a cutting procedure with a reduced relative speed in relation to the maximum speed according to FIG. 5;

FIG. 7 shows the arrangement according to FIG. 4 with the cutting teeth at the opposing reversal point;

FIG. 8 shows a perspective view of a first exemplary embodiment according to the invention of the shearing knife for use in a blade beam of the hedge trimmer according to FIG. 1 with a rough cut region on one side and with a trim cut region on the opposite side of the arrangement;

FIG. 9 shows a plan view of the blade arrangement according to FIG. 8 with details of the tooth spacing in the trim cut region in relation to the stroke of both shearing knives;

FIG. 10 shows a variant of the arrangement according to FIG. 9 with trim cut regions arranged on both sides;

FIG. 11 shows an enlarged detail view of cutting teeth with intermediate cutting spaces in the trim cut region according to FIGS. 8 to 10;

FIG. 12 shows a schematic view of individual cutting teeth of the trim cut region according to FIGS. 8 to 11 at their reversal points and with a graph-like illustration of their speed profile;

FIG. 13 shows the arrangement according to FIG. 12, according to which individual cutting teeth of the one shearing knife completely glide over associated cutting teeth of the other shearing knife with at least approximately maximum speed;

FIG. 14 shows the arrangement according to FIGS. 12 and 13 during the interaction of cutting teeth of both shearing knives near their reversal points with reduced relative speed;

FIG. 15 shows the arrangement according to FIG. 12 in the region of their opposing reversal points;

FIG. 16 shows an alternative exemplary embodiment of the arrangement according to FIGS. 12 to 15, wherein a cutting tooth is provided with sharp shearing blades and the cutting tooth interacting therewith is provided with blunt edges;

FIG. 17 shows a variant of the arrangement according to FIG. 16, wherein both interacting cutting teeth are each provided with a sharp shearing blade and a blunt edge;

FIG. 18 shows a further embodiment of a shearing knife according to the invention with different tooth spacings along the trim cut region with constant tooth width;

FIG. 19 shows the shearing knife according to FIG. 18 in reciprocal action with the indicated cutting teeth of a further, identical shearing knife;

FIG. 20 shows a variant of the shearing knife according to FIG. 18 with different tooth widths along the trim cut region with constant tooth spacings;

FIG. 21 shows the shearing knife according to FIG. 20 in reciprocal action with the indicated cutting teeth of a further, identical shearing knife;

FIG. 22 shows a schematic view of a further variant of the shearing knife according to FIGS. 18 and 20 with mutually identical, constant tooth spacings on a first side and likewise mutually identical and constant tooth spacings on the opposite second side, which, however, differ from the tooth spacings on the first side; and,

FIG. 23 shows the shearing knife according to FIG. 22 in reciprocal action with the cutting teeth of a further, identical shearing knife.

### DESCRIPTION OF THE PREFERRED EMBODIMENTS OF THE INVENTION

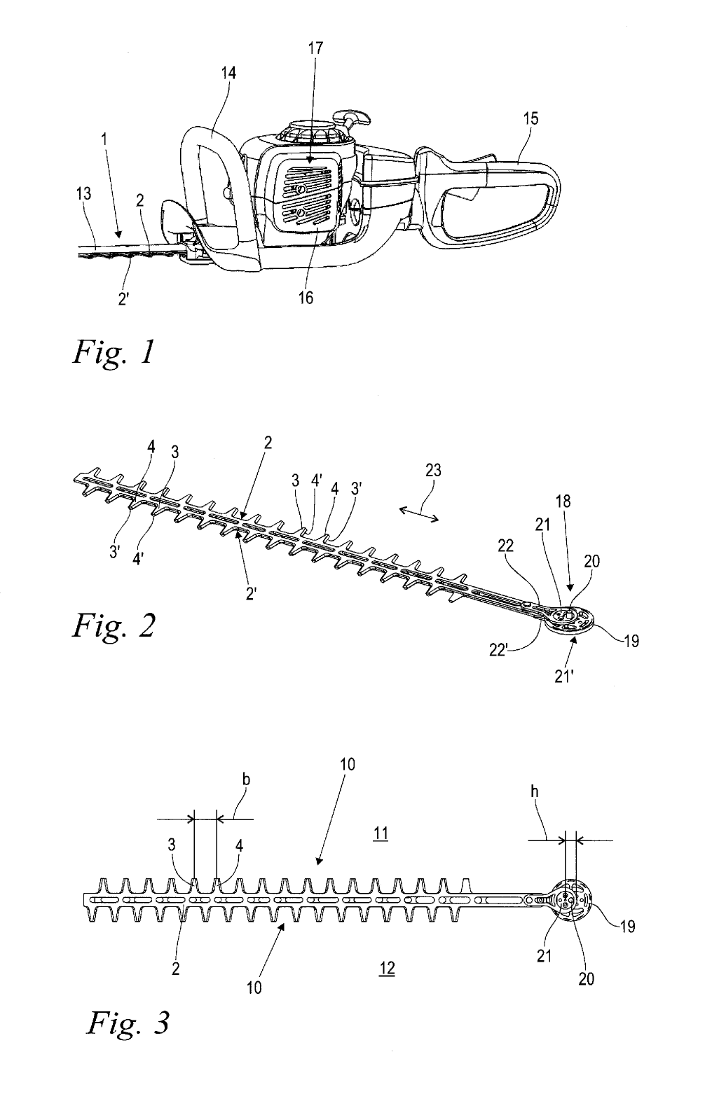

FIG. 1 shows a perspective view of a motor driven hedge trimmer having a blade beam 1. The hedge trimmer comprises a front handle 14 and a rear handle 15, between which a housing 16 for accommodating a motor 17 (not shown in more detail) is arranged. In the embodiment shown, the motor 17 is a two-stroke internal combustion engine, but may also be a four-stroke engine. Furthermore, an electric drive motor for mains or battery operation can also be practical. Starting from the housing 16, the blade beam 1 extends beyond the front handle 14. The blade beam 1 includes a longitudinal support 13 having two shearing knives (2, 2′) that are guided in a linearly movable manner thereon in its longitudinal direction. The two shearing knives (2, 2′) are driven in an oscillating manner in mutually opposite directions in the longitudinal direction by the motor 17. However, an embodiment in which one of the two shearing knives (2, 2′) is connected in a fixed and immovable manner to the longitudinal support 13, while the other shearing knife (2′, 2) alone is driven in an oscillating manner, can also be practical. In both cases, a relative movement oscillating in mutually opposite directions is established between the two shearing knives (2, 2′).

FIG. 2 shows a perspective view of the two flat shearing knives (2, 2′), which lie directly on each other, of the hedge trimmer of FIG. 1 in an embodiment according to the prior art. According thereto, the top shearing knife 2 is provided on both sides with cutting teeth (3, 4), while the bottom shearing knife 2′ likewise has corresponding cutting teeth (3′, 4′) on both sides.

Furthermore, there is provided a drive 18 which converts the rotating drive movement of the motor 17 (FIG. 1) into a linearly oscillating longitudinal movement of the two shearing knives (2, 2′) in accordance with a double arrow 23. The drive 18 can be configured as a link drive. In the exemplary embodiment shown, it is configured as a crank drive and accordingly comprises a crank disc 19 which is driven in rotation by the motor 17 (FIG. 1) about a central kingpin 20. Provided on the top side, illustrated here, of the crank disc 19 is an eccentric 21 which is arranged eccentrically with respect to the kingpin 20 and engages by means of a friction bearing in the connecting rod eye of a connecting rod 22 connected in an articulated manner to the top shearing knife 2. The underside of the crank disc 19 is provided in an analogous manner with a further eccentric 21′ (not shown in more detail) and a further connecting rod 22′ for driving the bottom shearing knife 2′, wherein both eccentrics (21, 21′) are arranged in a manner offset by 180° with respect to the rotation axis of the kingpin 20. The top eccentric 21 is shown in its furthest forward position facing the top shearing knife 2, and accordingly, the bottom eccentric 21′ (not shown) is located in its rearmost position. In the same way, the top shearing knife 2 is also in its furthest forward position, while the bottom shearing knife 2′ has been pulled back into its rearmost position. Here, the cutting teeth (3, 4) of the top shearing knife 2 lie in overlap with the cutting teeth (3′, 4′) of the bottom shearing knife 2′. Starting from the position shown in FIG. 2, a rotation of the crank disc 19 leads to an oscillating relative movement, in mutually opposite directions and phase-offset through 180°, of the two shearing knives (2, 2′) with respect to one another in accordance with the double arrow 23. In the opposite extreme position, which is not shown here and in which the top eccentric 21, together with the associated top shearing knife 2, takes up its rearmost position, and in which the bottom eccentric 21′ (not shown), together with the associated shearing knife 2′, takes up its furthest forward position, the cutting teeth (3, 4) of the top shearing knife 2 likewise lie in complete overlap with the associated cutting teeth (3′, 4′) of the bottom shearing knife 2′.

FIG. 3 shows a plan view of the arrangement according to FIG. 2, according to which the cutting teeth (3, 4) are arranged on both sides (11, 12) of the shearing knife 2 at regular and identical spacings (b) from one another.

The eccentric 21 has an eccentricity with respect to the kingpin 20 of the crank disc 19. This results in a stroke (h) of the shearing knife 2, which is twice the mentioned eccentricity with respect to the kingpin 20. The spacing (b) between two directly adjacent cutting teeth (3, 4) is twice as large as the single stroke (h) of the shearing knife 2.

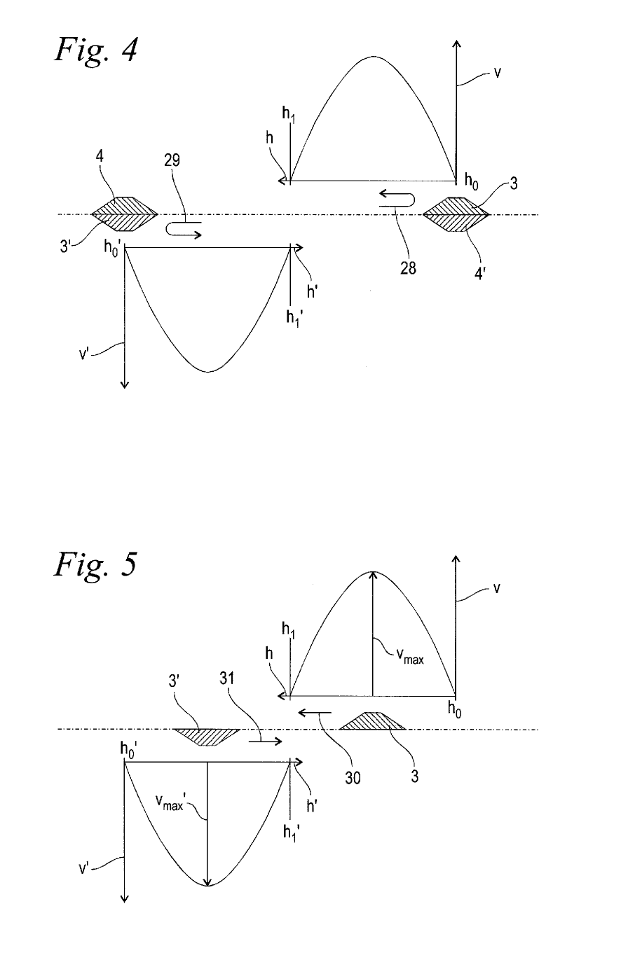

In an analogous manner, the same also applies to the spacing (b) between two directly adjacent cutting teeth (3′, 4′) of the bottom shearing knife 2′ (FIG. 2) and the associated stroke (h′), illustrated in FIGS. 4 to 7, of the bottom shearing knife 2′ (FIG. 2), wherein the stroke (h) of the top shearing knife 2 is equal to the stroke (h′) of the bottom shearing knife 2′, and wherein the same spacing (b) applies to all the cutting teeth (3, 4, 3′, 4′).

An overall relative stroke between the two shearing knives (2, 2′) can be formed by addition from the individual stroke (h) of the top shearing knife 2 and the individual stroke (h′) of the bottom shearing knife 2′. In the embodiment according to FIGS. 2 and 3, the spacing (b) between two adjacent cutting teeth (3, 4, 3′, 4′) is equal to the mentioned overall relative stroke or equal to the sum of the stroke (h) and the stroke (h′). Because of the above-mentioned relationship between the spacings (b) and the stroke (h, h′), a back cut region, that is a rough cut region 10, is formed on respective sides (11, 12) of the shearing knives (2, 2′) by way of which coarser branches, twigs or other material to be cut can be severed in a chipless and shearing manner.

FIGS. 4 to 7 show a schematic side view of cutting teeth (3, 4) of the top shearing knife 2 (FIGS. 1 to 3) in their reciprocal action with cutting teeth (3′, 4′) of the bottom shearing knife 2′ (FIGS. 1 to 3). Furthermore, by way of example for the cutting teeth (3, 3′), the profile of the speed (v, v′) thereof is plotted over respective ones of the associated strokes (h, h′) corresponding to the oscillating longitudinal movement in the direction of the double arrow 23 (FIG. 2). According to FIG. 4, the cutting teeth (3, 3′) are located at a first reversal point (h₀, h₀′), at which they, together with their associated shearing knives (2, 2′) (FIGS. 1, 3), undergo a reversal of direction in their movement in accordance with arrows (28, 29). In this state, the individual speed (v, v′) of the cutting teeth (3, 4, 3′, 4′) is zero. Starting from this, the respective speeds (v, v′) initially rise in the form of a half sine curve and then drop again until they are zero again at second reversal points (h₁, h₁,). The path difference between the reversal points (h₁, h₀) and (h₁′, h₀′) corresponds to the maximum stroke (h, h′) of the cutting teeth (3, 4, 3′, 4′), that is of the associated shearing knives (2, 2′) (FIGS. 1 to 3).

Starting from the first reversal point (h₀, h₀′) according to FIG. 4, two cutting teeth (3, 3′) move toward each other in accordance with arrows (30, 31), as is illustrated in FIG. 5. In accordance with the half-sinusoidal profile of their speeds (v, v′), they achieve individual maximum speeds (vₘₐₓ, vₘₐₓ′) without the cutting teeth (3, 3′) of the two shearing knives (2, 2′) coming into contact with each other.

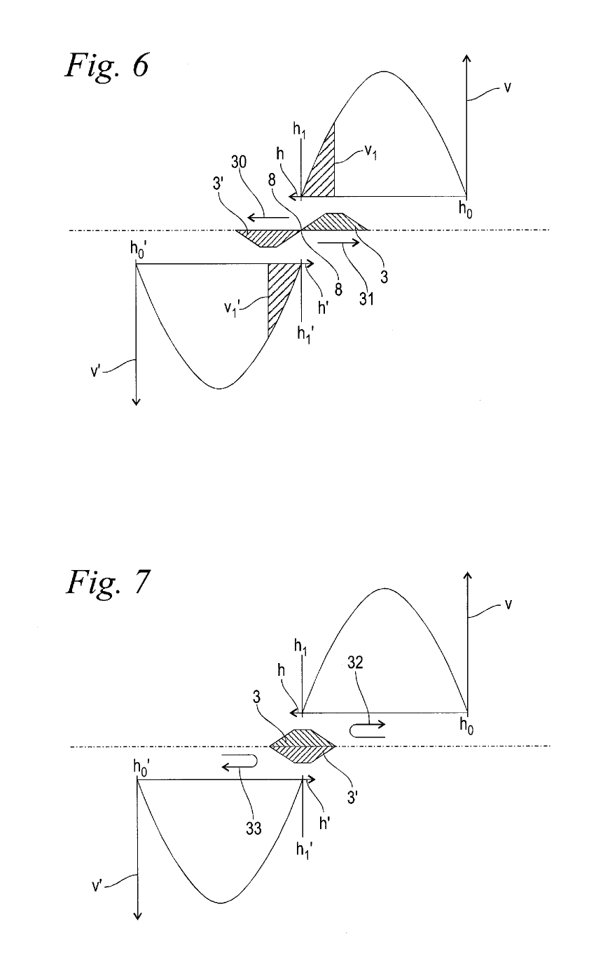

Only at a later point in time do the two cutting teeth (3, 3′) interact in a shearing manner, in that they come into contact with each other by way of their adjoining shearing cutting edges 8, in accordance with the illustration in FIG. 6. Here, the two cutting teeth (3, 3′) have respective individual speeds (v₁, v₁′) which are much less than the maximum speed vₘₐₓ or vₘₐₓ′ according to FIG. 5.

Finally, the two cutting teeth (3, 3′) reach their associated second reversal points (h₁, h₁′) as shown in FIG. 7, with the two cutting teeth (3, 3′) completely overlapping each other. Here, the associated individual speeds (v, v′) are each zero. Starting from this, a reversal in the movement direction takes place in accordance with arrows (32, 33), whereupon the movement cycle according to FIGS. 4 to 7 proceeds in the opposite order.

On account of the abovementioned geometric relationships between the spacings (b), the stroke (h) and the stroke (h′), only a single cut takes place at the meeting cutting teeth (3, 3′) in the course of one movement direction, this applying in an analogous manner also to meeting cutting teeth (4, 4′). Besides this single cut, no further cut takes place between the two reversal points (h₀, h₁) and (h₀′, h₁′). Furthermore, it can be seen from viewing FIGS. 6 and 7 together that this cutting operation takes place in a speed range which is bounded by the speeds (v₁, v₁′) according to FIG. 6 and the speeds (v, v′) of zero according to FIG. 7, in accordance with the hatched illustration in diagrams according to FIG. 6. The speeds (v, v′) of these speed ranges, which are illustrated in a hatched manner in FIG. 6 and in which the cutting teeth (3, 3′) associated with each other are in reciprocal action with each other, are much lower in magnitude than the respective maximum speeds (vₘₐₓ, vₘₐₓ′) according to FIG. 5.

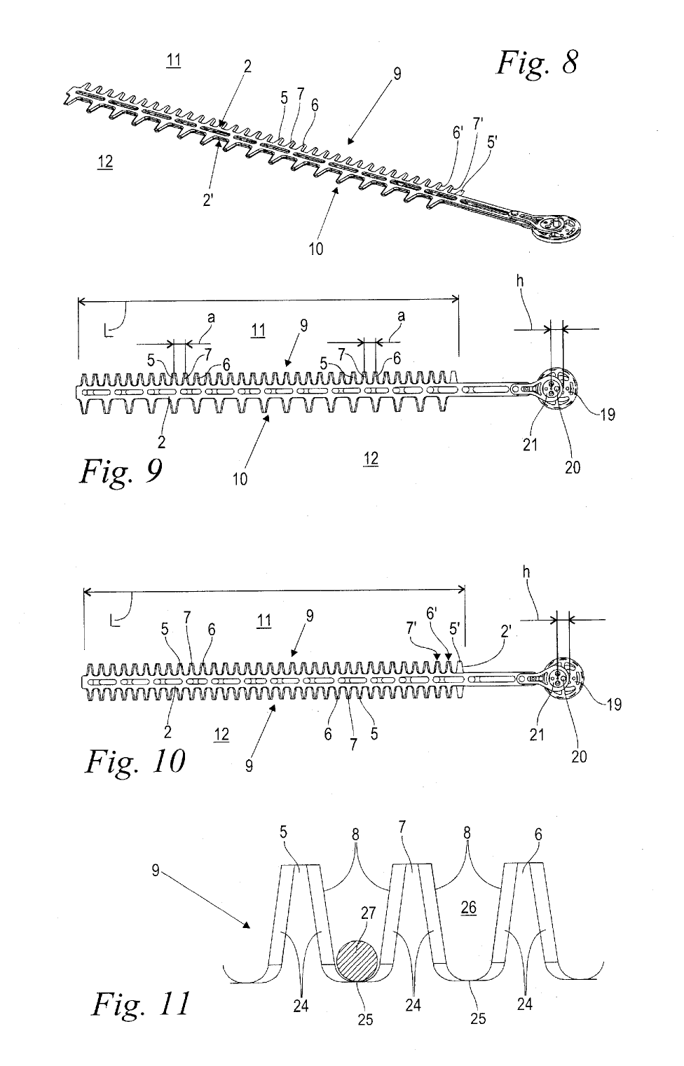

FIG. 8 shows a perspective view of a first exemplary embodiment according to the invention of shearing knives (2, 2′) for use in a blade beam 1 of a hedge trimmer according to FIG. 1. On one side 12, the shearing knives (2, 2′) are provided continuously with a rough cut region 10, the configuration of which is identical to the rough cut region 10 on the side 12 according to FIG. 3 and for which the same movement profile applies. On the opposite side 11, the shearing knives (2, 2′) are configured with a trim cut region 9, for which purpose the top shearing knife 2 is provided with cutting teeth (5, 6, 7) and the bottom shearing knife 2′ is provided with cutting teeth (5′, 6′, 7′).

FIG. 9 shows a plan view of the arrangement according to FIG. 8, according to which two directly adjacent cutting teeth (3, 4) of the rough cut region 10 are at a spacing (b) from one other, exactly as in the embodiment according to FIGS. 2 and 3. On the opposite side 11, cutting teeth (5, 6, 7, 5′, 6′, 7′) which are directly adjacent to each other are arranged at a spacing (a) from one another with respect to the longitudinal direction of the shearing knives (2, 2′).

The drive 18, together with the crank disc 19, kingpin 20, eccentric 21 and connecting rod 22, is configured in an identical manner to the embodiment according to FIGS. 2 and 3, and so there result the same stroke (h, h′) and the same relationship with respect to the spacing (b) in the rough cut region 10 in accordance with the illustrations according to FIGS. 4 to 7.

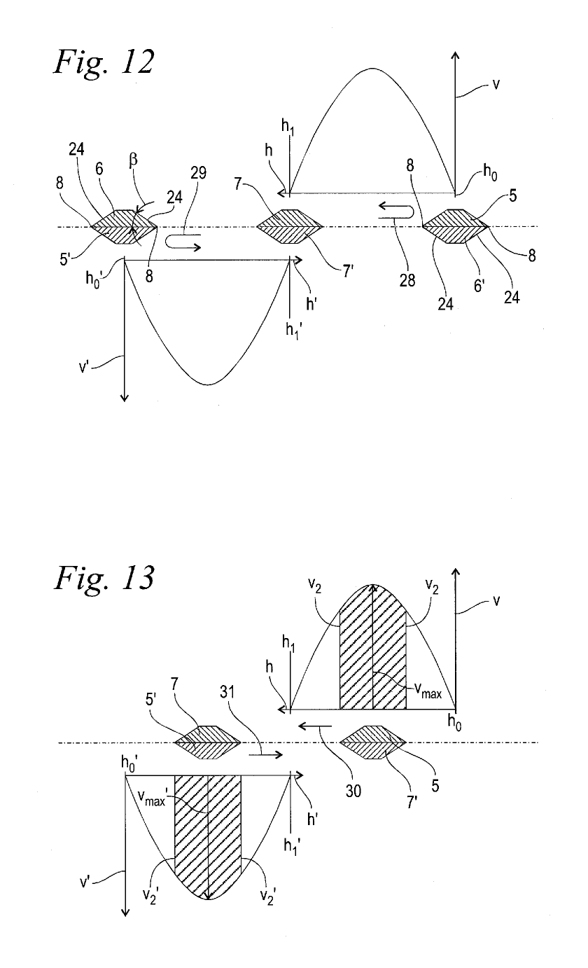

However, the spacing (b) between two adjacent cutting teeth (3, 4) in the rough cut region 10 is greater than the spacing (a) between two adjacent cutting teeth (5, 6, 7, 5′, 6′, 7′) in the trim cut region 9, and is twice the latter in the exemplary embodiment shown. As a result, a single spacing (a) between two directly adjacent cutting teeth (5, 6, 7, 5′, 6′, 7′) in the trim cut region 9 is equal to the single stroke (h) of the top shearing knife 2 or equal to the single stroke (h′) (FIGS. 12 to 15) of the bottom shearing knife 2′ (FIG. 8). Thus, the spacing (a) is also equal to half the sum of the stroke (h) of the one shearing knife 2 and the stroke (h′) of the other shearing knife 2′.

Furthermore, it is possible to derive from the abovementioned geometric relationships that in each case at least one, here exactly one third cutting tooth (7, 7′) is arranged between first cutting teeth (5, 5′) and second cutting teeth (6, 6′) of the two shearing knives (2, 2′). The third cutting teeth (7, 7′) thus lie in a directly adjacent manner between, in each case, a first cutting tooth (5, 5′) and a second cutting tooth (6, 6′). Furthermore, the spacing of a single first cutting tooth (5, 5′) in the trim cut region 9 from the next-but-one is equal to the spacing (b) between two directly adjacent cutting teeth (3, 4, 3′, 4′) of the rough cut region 10.

FIG. 10 shows a variant of the arrangement according to FIGS. 8 and 9, according to which both sides (11, 12) are configured as a trim cut region 9 having cutting teeth (5, 6, 7, 5′, 6′, 7′) according to the above stipulations. In this case, use is made of two identical shearing knives (2, 2′) in the blade beam 1, the bottom shearing knife 2′ of which is rotated through 180° about its longitudinal axis and is flapped from below against the top shearing knife 2. Both shearing knives (2, 2′) are formed in a symmetrical manner with respect to the trim cut region 9 on both sides, such that the cutting teeth (5, 6, 7, 5′, 6′, 7′) in the trim cut region 9 are arranged in a mirror-symmetrical manner with respect to the longitudinal axis of the shearing knives (2, 2′).

It can be seen in FIGS. 9 and 10 that the blade beam (FIG. 1) has a usable length L for the cut to be carried out, along which length L the cutting teeth (3, 4, 5, 6, 7) and cutting teeth (3′, 4′, 5′, 6′, 7′) extend. In both cases, the trim cut regions 9 extend along the entire usable length L. The same also applies to the rough cut region 10 according to FIG. 9. However, it can also be expedient to provide only a shorter trim cut region 9, which is adjoined by a rough cut region 10 on the same side (11, 12) in the direction of the usable length L.

The shearing knives (2, 2′) are connected releasably to the drive 18 and to the longitudinal support 13 of the blade beam 1 (FIG. 1) and are therefore exchangeable. Thus, depending on choice and requirement, shearing knives (2, 2′) in the embodiment according to FIGS. 2 and 3, in the embodiment according to FIGS. 8 and 9 or in the embodiment according to FIG. 10 can be used. Furthermore, a configuration in which different blade beams 1 (FIG. 1) are equipped with the different abovementioned variants of the shearing knives (2, 2′) and are exchangeable as a whole may be practical. In particular, a further blade beam having at least one rough cut region 10 and without a trim cut region 9, for example according to FIGS. 2 to 7, may be provided, wherein the blade beam 1 having the at least one trim cut region 9 in accordance with FIGS. 1 and 8 to 17 is exchangeable for the further blade beam without a trim cut region 9.

FIG. 11 shows an enlarged detail view of details of the geometric configuration of the cutting teeth (5, 6, 7) in the trim cut region 9. According thereto, the cutting teeth (5, 6, 7) have a trapezoidal outline, wherein in each case a likewise trapezoidal cutting space 26 remains between the cutting teeth (5, 6, 7) with respect to the longitudinal direction of the blade beam 1 and the shearing knives (2, 2′) (FIG. 1). The cutting teeth (5, 6, 7) extend transversely to the longitudinal axis of the blade beam 1 (FIG. 1), starting from a tooth root 25 up to outer free ends, and, on both sides of their flanks facing the cutting spaces 26, are provided with bevels 24 to form shearing cutting edges 8. The bevels 24 and the shearing cutting edges 8 extend from the outer tooth tips to the tooth root 25. The tooth root 25 is wide enough for schematically illustrated material 27 to be cut having an at least approximately circular cross section to be able to be introduced into the cutting space 26 between mutually facing shearing cutting edges 8 right down to the tooth root 25, and in the process to lie completely between two mutually facing shearing cutting edges 8. The cutting teeth (5′, 6′, 7′) of the further shearing knife 2′ (FIGS. 8 to 10) are configured in the same way. Furthermore, the same applies in a corresponding manner to the cutting teeth (3, 4, 3′, 4′) of the shearing knives (2, 2′) (FIGS. 8 to 10) in the rough cut region 10.

FIG. 12 shows a cross-sectional illustration of the cutting teeth (5, 6, 7) of the top shearing knife 2 and of the cutting teeth (5′, 6′, 7′) of the bottom shearing knife 2′ (FIGS. 8 to 11) in the associated trim cut region 9, according to which the cutting teeth (5, 6, 7) rest flat and without a gap directly on the associated cutting teeth (5′, 6′, 7′) of the bottom shearing knife 2′. Including the associated shearing knives (2, 2′), they are formed overall from flat, planar steel sheet metal and are provided with the respective bevels 24 only on their mutually remote sides. As a result, in the event of the cutting teeth (5, 6, 7) overlapping the further cutting teeth (5′, 6′, 7′), the associated shearing cutting edges 8 come into direct contact with each other.

Furthermore, the mutually facing flat sides of the cutting teeth (5, 6, 7, 5′, 6′, 7′) form a wedge angle β with the associated bevels 24 on the respective shearing cutting edge 8. Since the abovementioned flat sides extend parallel to the movement direction, the mentioned wedge angle β is also equal to the cutting angle and is ≦45°, here approximately 30°. This applies in the same manner also to the cutting teeth (3, 4, 3′, 4′) in the rough cut region 10 according to FIGS. 8 and 9. Overall, all of the cutting teeth (3, 4, 5, 6, 7, 3′, 4′, 5′, 6′, 7′) are thus provided with such shearing cutting edges 8 and are thus designed for the chipless, shearing severing of the material 27 to be cut (FIG. 11) in contrast with a chip-removing sawing cut.

FIGS. 12 to 15 show schematic side views of the interaction between the cutting teeth (5, 6, 7) of the one shearing knife 2 and the cutting teeth (5′, 6′, 7′) of the other shearing knife 2′ in the trim cut region 9 (FIGS. 8 to 11). As also in FIGS. 4 to 7, in each case the profile of the individual speeds (v, v′) over the associated stroke (h, h′) is plotted here by way of example for the first cutting teeth (5, 5′). In an analogous manner to the illustration according to FIGS. 4 to 7, the cutting teeth (5, 6, 7) and the cutting teeth (5′, 6′, 7′) execute oscillating movements with a half-sinusoidal profile of the associated speed (v, v′) between first reversal points (h₀, h₀′) and second reversal points (h₁, h₁′). In this case, they execute relative movements in accordance with the arrows (28, 29, 30, 31, 32, 33) between the reversal points (h₀, h₁, h₀′, h₁′), analogously to the illustration according to FIGS. 4 to 7.

In the region of the first reversal points (h₀, h₀′), the first cutting teeth (5, 5′) lie, according to FIG. 12, in overlap with the vertically opposite second cutting teeth (6′, 6). At the second reversal points (h₁, h₁′) according to FIG. 15, the first cutting tooth 5 is in overlap with the vertically opposite first cutting tooth 5′. In both cases, the speed (v) of the first cutting teeth (5, 5′) is zero. This also applies to all of the remaining cutting teeth (6, 7, 6′, 7′).

Starting from the first reversal points (h₀, h₀′), the first cutting teeth (5, 5′) move towards one another in accordance with arrows (30, 31), as is illustrated in FIG. 13. Since, however, in contrast to the illustration according to FIGS. 4 to 7, third cutting teeth (7, 7′) are arranged between the first cutting teeth (5, 5′) and the second cutting teeth (6, 6′), the first cutting teeth (5, 5′) completely glide over these third cutting teeth (7′, 7) at a speed (v, v′) which results from the geometric coordination, described above in connection with FIG. 9, of the spacings a between the cutting teeth (5, 6, 7, 5′, 6′, 7′) with the stroke (h) and with the stroke (h′). From the speed diagrams in FIG. 13, this complete gliding over takes place at speeds (v, v′) which are bounded by speeds (v₂, v₂′) in accordance with the hatched regions illustrated there and which include the respective maximum speeds (vₘₐₓ, vₘₐₓ′).

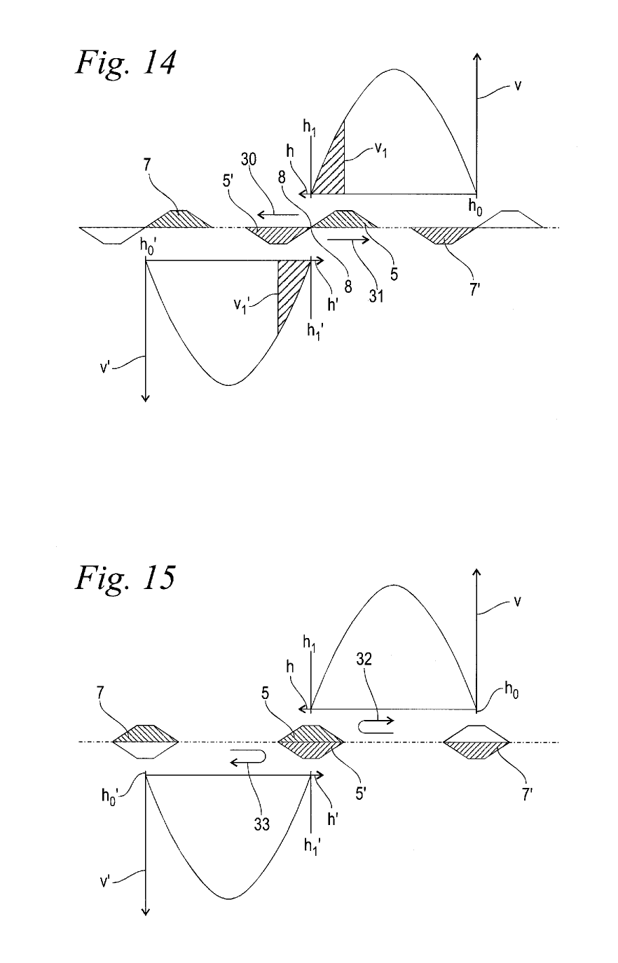

In the further course of their travel, the cutting teeth 5 come into contact with the cutting teeth 5′, in accordance with the illustration according to FIG. 14 at reduced speeds (v₁, v₁′) compared with the speeds (v₂, v₂′) according to FIG. 13, with the same conditions as described in connection with FIG. 6 being established.

It is clear from the above statements that the chipless shearing cut takes place at higher speeds (v, v′) when the third cutting teeth (7′, 7) are glided over by means of the first cutting teeth (5, 5′) according to FIG. 13 than in the case of the chipless shearing cut in accordance with the illustrations according to FIGS. 4 and 14. It is assumed that, on account of these increased individual speeds (v, v′), the cutting result, in particular in the case of thin, flexible or tough material 27 to be cut (FIG. 11), is improved. Furthermore, in the trim cut region 9 (FIGS. 8 to 10), in contrast to the rough cut region 10 (FIGS. 3 to 9), a double severing cut takes place in only one direction during a single stroke (h), namely when the first cutting teeth (5, 5′) come into contact with the third cutting teeth (7′, 7) according to FIG. 13, and when the first cutting teeth (5, 5′) according to FIG. 14 come into contact, thereby increasing the cutting performance. For coarser material 27 to be cut (FIG. 11), which cannot be readily introduced into the narrow cutting spaces 26 between the cutting teeth (5, 6, 7) of the trim cut region 9 according to FIG. 11, it is possible, however, as required, to use the rough cut region 10 according to FIGS. 8 and 9, the cutting profile of which corresponds to that in FIGS. 4 to 7.

The abovementioned cutting profiles in the trim cut region 9 according to FIGS. 12 to 15 are illustrated by way of example for first cutting teeth (5, 5′) in connection with third cutting teeth (7′, 7).

However, the same applies correspondingly for any other cutting tooth (5, 6, 7, 5′, 6′, 7′) of the two shearing knives (2, 2′) in the trim cut region 9 (FIGS. 8 to 11). Unless stated to the contrary, the further features and reference signs of the cutting teeth (3, 4, 3′, 4′) of the rough cut region 10 otherwise correspond to those of the cutting teeth (5, 6, 7, 5′, 6′, 7′) of the trim cut region 9.

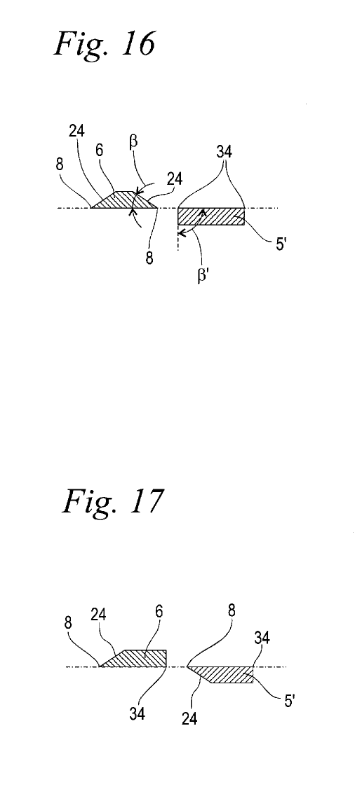

FIG. 16 shows an alternative embodiment of the arrangement according to FIGS. 12 to 15. In this case, not all of the cutting teeth (5, 6, 7, 5′, 6′, 7′) are provided with sharpened shearing cutting edges 8. Instead, a cutting tooth 6 and a further cutting tooth 5′ that interacts therewith are illustrated here by way of example. The cutting tooth 6 is provided, in the same way as described above, with two sharpened shearing cutting edges 8 and associated bevels 24, wherein the shearing cutting edges 8 have the above-described wedge angle β. However, the cutting tooth 5′ interacting therewith has no such shearing cutting edges 8, but rather edges 34 having a more obtuse wedge angle β′. In the exemplary embodiment shown, the wedge angle β′ is about 90°, but can also have a different magnitude. The interaction of two cutting teeth (6, 5′) is illustrated here only by way of example. Expediently, however, the other cutting teeth (5, 7, 6′, 7′) are also provided alternately with shearing cutting edges 8 or with edges 34. During the cutting cycle according to FIGS. 12 to 15, in the exemplary embodiment according to FIG. 16, a sharpened shearing cutting edge 8 always comes into contact with an edge 34, as a result of which the above-described chipless shearing cut is likewise brought about.

FIG. 17 shows a variant of the arrangement according to FIG. 16, wherein both interacting cutting teeth (6, 5′) are each provided with a sharp shearing cutting edge 8 and a blunt edge 34. The same also applies to the remaining cutting teeth (5, 7, 6′, 7′), which are not illustrated. The shearing cutting edges 8 and edges 34 are configured in the same way as in the exemplary embodiment according to FIG. 16. Here, too, in each case sharp shearing cutting edges 8 come into contact with blunt edges 34 during the cutting cycle according to FIGS. 12 to 15 in order to create the chipless shearing cut.

The geometric and kinematic relationships described and illustrated above are explained by way of an exemplary embodiment in which both shearing knives (2, 2′) are movable in an oscillating manner in opposite directions between two reversal points (h₀, h₁, h₀′, h₁′), wherein the stroke (h) of the one shearing knife 2 has the same magnitude as the stroke (h′) of the other shearing knife 2′. However, the geometric and kinematic relationships apply in the same or an analogous way also to embodiments that are likewise according to the invention, in which the stroke (h) of the one shearing knife 2 differs in magnitude from the stroke (h′) of the other shearing knife 2′. In particular, the mentioned relationships apply also for such embodiments according to the invention, in which only one shearing knife 2 is movable in an oscillating manner through a stroke (h) between two reversal points (h₀, h₁), while the other shearing knife 2′ is stationary with respect to the blade beam 1. The stroke (h′) of this stationary shearing knife 2′ is then zero and the associated reversal points (h₀′, h₁′) coincide with one another.

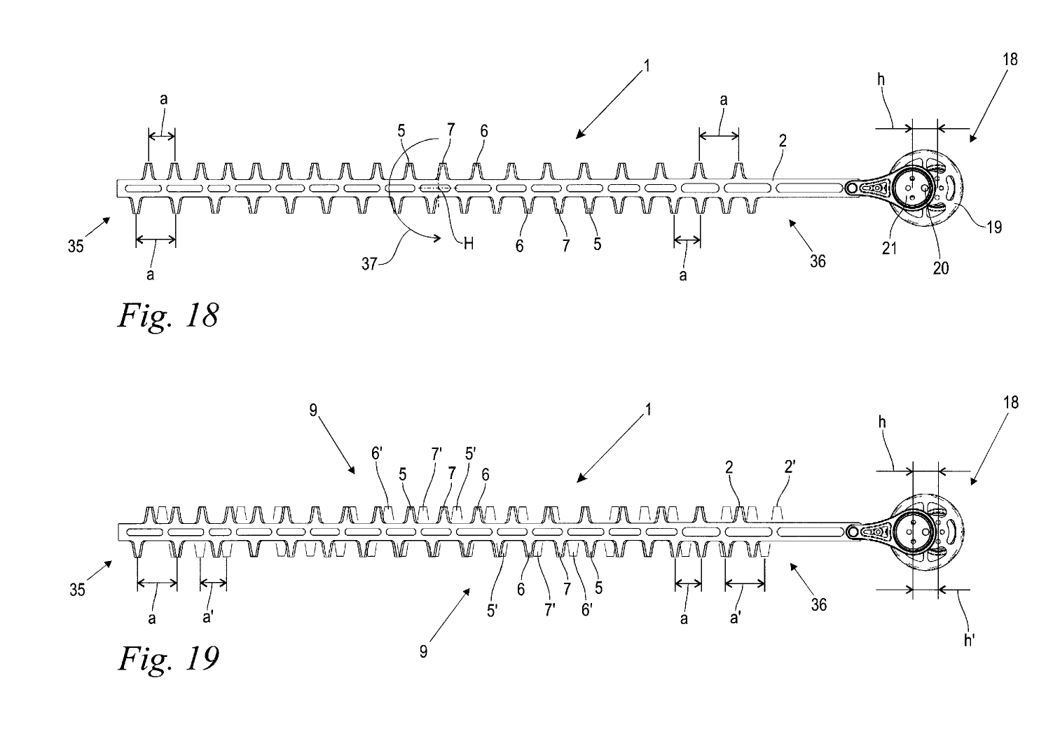

FIG. 18 shows a plan view of a further embodiment of a blade beam 1 configured according to the invention, in which, besides the drive 18, only a single shearing knife 2 is illustrated for the sake of improved clarity. For the sake of completeness, the further shearing knife 2′ is still illustrated in outline in FIG. 19.

With regard to its longitudinal direction, the blade beam 1 has an end 35 remote from the drive 18 and an opposite end 36 adjacent to the drive 18. Unlike in the case of the shearing knives (2, 2′) of the above-described exemplary embodiments, in which the spacings (a, b) between the cutting teeth (5, 6, 7, 5′, 6′, 7′) are constant along the entire extent of the shearing knives (2, 2′), in the exemplary embodiment shown, differently or unequally distributed spacings (a) between the cutting teeth (5, 6, 7, 5′, 6′, 7′) are selected within the trim cut regions 9 arranged on both sides. On the one side of the shearing knife 2, the spacings (a) are smaller in the region of the end 35 than in the region of the opposite end 36, wherein the spacings (a) become larger in at least approximately identical increments starting from the one end 35 in the direction of the opposite ends 36 thereof. On the opposite side of the shearing knife 2 shown, it is precisely the opposite: there, the spacings a become smaller in at least approximately identical increments from the end 35 in the direction of the opposite end 36. The smallest spacing (a) on each side is equal to half the sum of the stroke (h) of the one shearing knife 2 and the stroke (h′) of the other shearing knife 2′ (FIG. 19). Since both shearing knives (2, 2′) (FIG. 19) are configured identically, and execute the same stroke (h, h′), the smallest spacing (a) is thus equal to the stroke (h) or equal to the stroke (h′). Proceeding therefrom, the remaining spacings (a) are larger and reach a maximum value of preferably up to twice the smallest spacing (a).

The spacings (a, a′) that vary along the length of the shearing knives (2, 2′) are brought about in that the width of the individual cutting teeth (5, 6, 7) is at least approximately identical, while the widths of the tooth intermediate spaces vary.

In operation, two identical shearing knives (2, 2′) are used, wherein the second shearing knife 2′ is rotated through 180° about its longitudinal axis with respect to the first shearing knife 2 and is folded from below against the top shearing knife 2. This case is illustrated in FIG. 19, wherein the second shearing knife 2′ having its cutting teeth (5′, 6′, 7′) and the associated spacings (a′) is illustrated only by way of dashed lines in FIG. 19. A respective trim cut region 9 is provided on both sides of the blade beam 1. To this end, both shearing knives (2, 2′) are formed in a symmetrical manner within the trim cut regions 9 on both sides, such that their cutting teeth (5, 6, 7, 5′, 6′, 7′) are arranged in the trim cut region 9 in a rotationally symmetrical manner with respect to a vertical axis located centrally perpendicularly on the trim cut region 9 and perpendicular to the plane of the drawing. In other words, the rotational symmetry from viewing FIGS. 18 and 19 together means that the entire arrangement of the cutting teeth (5, 6, 7, 5′, 6′, 7′) on one side of the shearing knife (2, 2′) can be brought into overlap with the entire arrangement of the cutting teeth (5, 6, 7, 5′, 6′, 7′) on the opposite side of the same shearing knife (2, 2′) by rotation through 180°, when the imaginary 180° rotation takes place in accordance with an arrow 37 about an imaginary vertical axis H which is perpendicular to the plane of the respective shearing knife (2, 2′) and in the process extends centrally through the trim cut region 9 or through the region having the cutting teeth (5, 6, 7, 5′, 6′, 7′).

It can be seen from viewing FIGS. 18 and 19 together and from the above explanations that on one side of the blade beam 1 the spacings between the cutting teeth (5, 6, 7) become larger from the one end 35 in the direction of the opposite end 36, while the spacings (a′) between the cutting teeth (5′, 6′, 7′) of the associated other shearing knife 2′ on the same side of the blade beam and starting from the same end 35 become smaller in the direction of the opposite end 36 thereof. On the opposite side of the blade beam 1, this is precisely the opposite in accordance with the abovementioned rotational symmetry: there, the spacings between the cutting teeth (5, 6, 7) become smaller from the one end 35 in the direction of the opposite end 36, while the spacings (a′) between the cutting teeth (5′, 6′, 7′) of the associated other shearing knife 2′ become larger from the same end 35 in the direction of its opposite end 36. As a result, the blade beam 2 interacts in the region of its small spacings (a) with the blade beam 2′ in the region having large spacings (a′) and vice versa. It is clear from the diagrammatic illustration according to FIG. 19 that not all of the cutting teeth (5, 6, 7, 5′, 6′, 7′) execute shearing at the same time. Rather, at a particular point in time only some cutting teeth (5, 6, 7, 5′, 6′, 7′) execute shearing, while at the same time at a different location free spaces remain therebetween for the introduction of the material to be cut. However, in the course of the stroke (h, h′), shearing is carried out in all of the sections of the blade beam 1.

Furthermore, it can be seen that, while retaining the principle according to the invention which was described with the above-described exemplary embodiments, a single cutting tooth 7 of the one shearing knife 2 can be completely glided over by cutting teeth (5′, 6′) of the other shearing knife 2′ during the stroke (h, h′) at least in sections on both sides of the blade beam 1.

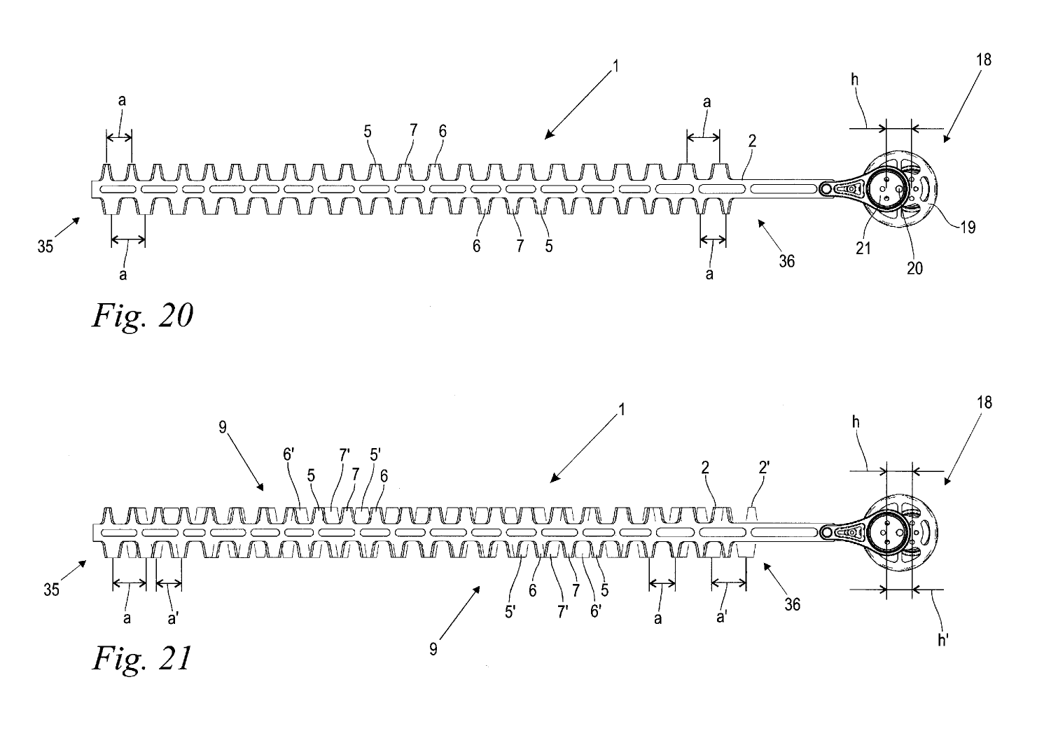

FIGS. 20 and 21 show another variant of the arrangement according to FIGS. 18 and 19, in which the different spacings (a, a′) between the cutting teeth (5, 6, 7, 5′, 6′, 7′) are formed by different tooth widths while the widths of the tooth intermediate spaces remain essentially the same. Of course, a combination of varying tooth widths with varying widths of the tooth intermediate spaces is also possible. The remaining features and reference signs of the exemplary embodiment according to FIGS. 20 and 21 correspond to those of the exemplary embodiment according to FIGS. 18 and 19.

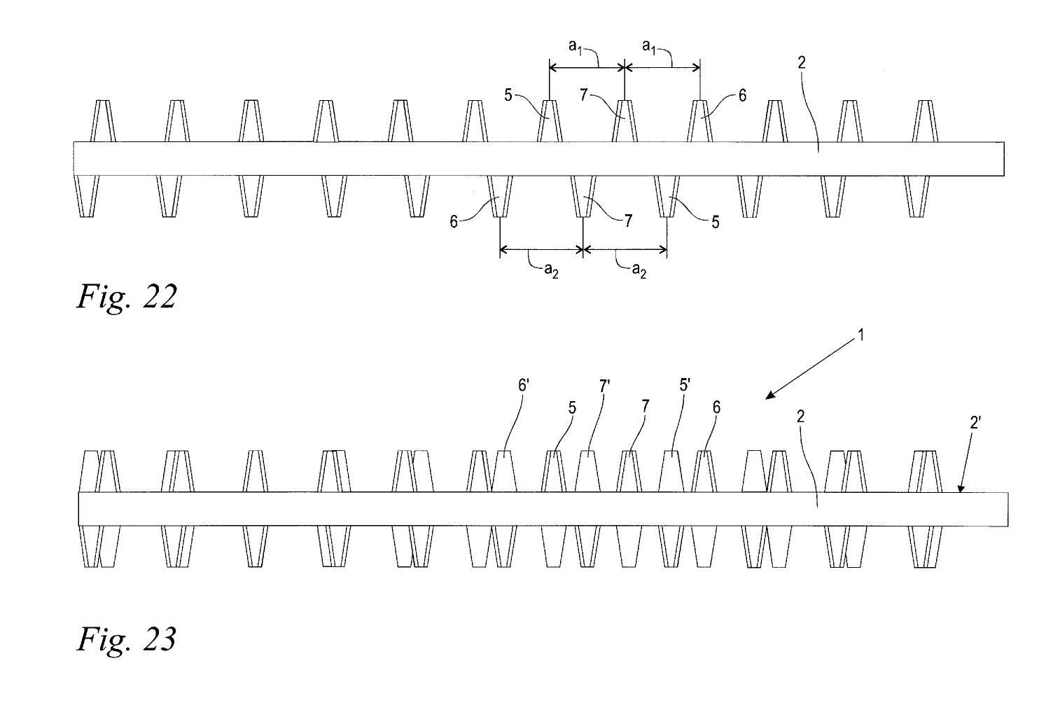

FIGS. 18 to 21 show exemplary embodiments having varying spacings (a, a′) between the cutting teeth (5, 6, 7, 5′, 6′, 7′) on both shearing knives (2, 2′). It follows from this that, at least in a sub-section of the trim cut region 9, the cutting teeth (5, 6, 7) of the one shearing knife 2 are at a spacing a from one another which differs from the spacing (a′) between the associated cutting teeth (5′, 6′, 7′) of the other shearing knife 2′. However, the same principle and thus the same mode of operation can also be achieved, for example, in that the cutting teeth (5, 6, 7) of the one shearing knife 2 are at a mutually identical spacing a and that the cutting teeth (5′, 6′, 7′) of the other shearing knife 2′ are likewise at a mutually identical spacing (a′), but the spacings a between the cutting teeth (5, 6, 7) of the one shearing knife 2 differ from the spacings (a′) between the associated cutting teeth (5′, 6′, 7′) of the other shearing knife 2′. Such a case is illustrated schematically in FIGS. 22 and 23.

FIG. 22 shows a shearing knife 2, the cutting teeth (5, 6, 7) on a first side of which are at an identical, constant spacing (a₁) from one another along the shearing knife 2. On the opposite second side, the cutting teeth (5, 6, 7) are at an identical, constant spacing (a₂) from one another along the shearing knife 2. The spacings (a₁) that are identical to one another on the first side are smaller than the spacings (a₂) that are identical to one another on the second side.

In operation, two identical shearing knives (2, 2′) are used, wherein the second shearing knife 2′ is rotated through 180° about its longitudinal axis with respect to the first shearing knife 2 and is flapped from below against the top shearing knife 2. This case is illustrated in FIG. 23, wherein the cutting teeth (5′, 6′, 7′) of the second shearing knife 2′ having their larger, but mutually identical spacings (a₂) interact with the cutting teeth (5, 6, 7) of the first shearing knife 2 having their smaller, but mutually identical spacings (a₁). In a similar manner to in the exemplary embodiments according to FIGS. 19 and 21, not all of the cutting teeth (5, 6, 7, 5′, 6′, 7′) interact with one another simultaneously, but sever the material to be cut at different locations on the blade beam 1 at different points in time, that is, in a time-offset manner with respect to one another. The entire arrangement, including drive, mounting, et cetera, is relieved of load as a result.

Over and above the exemplary embodiments as per FIGS. 1 to 23, however, a combination of identical spacings a of the cutting teeth (5, 6, 7) of one shearing knife 2 with varying spacings (a′) between the cutting teeth (5′, 6′, 7′) of the other shearing knife 2′ is also possible.

However, in any case, it is expedient for the tooth spacings, the tooth widths, the tooth intermediate spaces and the stroke (h, h′) (FIG. 21) to be coordinated with each other such that as far as possible all of the cutting teeth (5, 6, 7, 5′, 6′, 7′) of the one shearing knife (2, 2′) are as far as possible completely in overlap with the associated cutting teeth (5′, 6′, 7′, 5, 6, 7) of the other shearing knife (2′, 2) at the reversal points (h₀, h₁, h₀′, h₁′) (FIG. 15), as is also illustrated in FIG. 15. As a result, damage to the material 27 to be cut by exposed shearing cutting edges 8 (FIG. 11) is avoided. If a complete overlap cannot be achieved, the overlap should however be at least so large at the reversal points (h₀, h₁, h₀′, h₁′) (FIG. 15) that the material 27 to be cut can be introduced into the intermediate spaces between the cutting teeth (5, 6, 7) in accordance with the illustration according to FIG. 11 in order to be completely severed.

Unless otherwise described, the remaining features and reference signs of the exemplary embodiments according to FIGS. 18 to 23 otherwise also correspond with those of the above-described exemplary embodiments.

It is understood that the foregoing description is that of the preferred embodiments of the invention and that various changes and modifications may be made thereto without departing from the spirit and scope of the invention as defined in the appended claims.

What is claimed is:

1. A blade beam of a motor driven hedge trimmer, said blade beam comprising:
a first and a second shear knife, at least one of said first and said second shear knives being configured to be moveable in an oscillating manner counter to the other one of said shearing knives by a stroke between two reversal points;
said first and said second shear knives each having cutting teeth which are arranged at a distance (a) one from the other;
said cutting teeth of said first shear knife and said cutting teeth of said second shear knife being configured to act in opposition to each other;
a portion of said cutting teeth having cutting edges for carrying out a chipless, shearing severing of material to be cut;
said first and said second shear knives having respective first cutting teeth;
said first and said second shear knives being configured so as to cause said first cutting tooth of one of said first and second shear knives to be at least in partial overlapment with said first cutting tooth of the other one of said first and said second shear knives at said two reversal points;
a trim cut region having at least a subset of said cutting teeth including said first cutting tooth, a second one of said cutting teeth and a third one of said cutting teeth disposed between said first and second cutting teeth;
said cutting teeth in said trim cut region being at said distance (a) from each other; and,
said distances (a) between the three cutting teeth and said stroke being matched to each other so as to cause said first cutting tooth of one of said first and said second shear knives to completely glide over the third cutting tooth of said other one of said first and said second shear knives as said first shear knife moves between said two reversal points.

2. The blade beam of claim 1, wherein said third cutting tooth is arranged between and directly adjacent to said first and said second cutting teeth.

3. The blade beam of claim 1, wherein the distances (a) between said cutting teeth of one of said first and said second shear knives is constant in said trim cut region.

4. The blade beam of claim 1, wherein said distances (a) between said cutting teeth of the trim cut region of said first and said second shear knives is constant.

5. The blade beam of claim 3, wherein:
said first and said second shear knives are both configured to be moveable through corresponding strokes; and,
said distance (a) between said cutting teeth in said trim cut region is equal to half the sum of the stroke (h) of said first shear knife and the stroke (h′) of said second shear knife.

6. The blade beam of claim 1, wherein, in a part section of the trim cut region, the cutting teeth of one of said shearing knives are at a distance (a) to each other which deviates from the distance (a′) between the corresponding cutting teeth of the other one of said shearing knives.

7. The blade beam of claim 6, wherein said distances (a) between said cutting teeth of one of said first and second shear knives is uneven in the course of the trim cut region.

8. The blade beam of claim 6, wherein said distances (a) between said cutting teeth of said first and said second shear knives is uneven in the course of the trim cut region.

9. The blade beam of claim 6, wherein said distance (a) between the cutting teeth in the trim cut region is at least as great as half the sum of the stroke (h) of the first shear knife and the stroke (h′) of the second shear knife.

10. The blade beam of claim 6, wherein:
said distances (a) between said cutting teeth of said first shear knife increase from a first end of said blade beam to the opposite second end of said blade beam and said distances (a′) between the teeth of said second shear knife decrease from said opposite second end to said first end of said blade beam.

11. The blade beam of claim 1, wherein said blade beam has a length (L) usable for the cut; and, the trim cut region extends over the entire usable length (L) of said blade beam at least on one side thereof.

12. The blade beam of claim 1, wherein said blade beam has two opposite lying sides; and, said trim cut region is a first trim cut region on one of two sides; and, further comprises a second trim cut region on the other one of said two sides.

13. The blade beam of claim 12, wherein said first and second shear knives are identical.

14. The blade beam of claim 13, wherein said shear knives are configured to be symmetrical referred to the trim cut region on both of said sides.

15. The blade beam of claim 1, wherein said blade beam has first and second sides lying opposite each other; said trim cut region is arranged on one of said first and second sides; said blade beam further comprises a coarse cut section having cutting teeth arranged at a uniform distance (b) from each other; and, said distance (b) in said coarse cut regions is greater than said distance (a) of the cutting teeth in said trim cut region.

16. The blade beam of claim 15, wherein said distance (b) of the cutting teeth in said coarse cut region is twice the distance (a) of the cutting teeth in said trim cut region.

17. The blade beam of claim 1, wherein said first and second shear knives are counter oscillatingly movable through a stroke between two reversal points.

18. The blade beam of claim 17, wherein the stroke (h) of one of said shear blades and the stroke (h′) of the other shear blade each have the same magnitude.

19. The blade beam of claim 1, wherein all of said cutting teeth are provided with cutting edges for the chipless, shearing severing of material to be cut.

20. The blade beam of claim 1, wherein said first and second shear knives are exchangeable.

21. A motor-driven hedge trimmer comprising:
a first blade beam including:
a first and a second shear knife, at least one of said first and said second shear knives being configured to be moveable in an oscillating manner counter to the other one of said shearing knives by a stroke between two reversal points;
said first and said second shear knives each having cutting teeth which are arranged at a distance (a) one from the other;
said cutting teeth of said first shear knife and said cutting teeth of said second shear knife being configured to act in opposition to each other;
a portion of said cutting teeth having cutting edges for carrying out a chipless, shearing severing of material to be cut;
said first and said second shear knives having respective first cutting teeth;
said first and said second shear knives being configured so as to cause said first cutting tooth of one of said first and second shear knives to be at least in partial overlapment with said first cutting tooth of the other one of said first and said second shear knives at said two reversal points;
a trim cut region having at least a subset of said cutting teeth including said first cutting tooth, a second one of said cutting teeth and a third one of said cutting teeth disposed between said first and second cutting teeth;
said cutting teeth in said trim cut region being at said distance (a) from each other;
said distances (a) between the three cutting teeth and said stroke being matched to each other so as to cause said first cutting tooth of one of said first and said second shear knives to completely glide over the third cutting tooth of said other one of said first and said second shear knives as said first shear knife moves between said two reversal points;
a second blade beam including a coarse cut region in lieu of said trim cut region; and,
said first blade beam being exchangeable for said second blade beam.
